(19) United States
(12) Patent Application Publication
(10) Pub. No.: US 2020/0300028 A1
(43) Pub. Date: Sep. 24, 2020

(54) Trailer Door System

(71) Applicants: Kirkland A. Towles, Jacksonville, FL (US); Corey D. Towles, Jacksonville, FL (US); Jason L. Baker, Jacksonville, FL (US)

(72) Inventors: Kirkland A. Towles, Jacksonville, FL (US); Corey D. Towles, Jacksonville, FL (US); Jason L. Baker, Jacksonville, FL (US)

(21) Appl. No.: 16/358,776

(22) Filed: Mar. 20, 2019

(51) Int. Cl. E06B 3/50; E05D 3/02

(52) U.S. Cl. CPC E06B 3/50; E05Y 2900/531; E05D 3/02

(57) ABSTRACT

This is a door system that allows for a pair of doors on a trailer or utility vehicle to be hingedly opened on a vertical axis or on a horizontal axis. Additionally, the door system described herein allows for each door to operate independently of one another or to operate in unison with each other. This is useful for individuals that use trailers frequently, because it allows for the use of one trailer providing two doors uniquely capable of opening as barn-doors, as a ramp, or as both a door and a ramp.

### CROSS-REFERENCE TO RELATED PATENT APPLICATIONS

This patent application claims the benefit of U.S. Provisional Application 62/646,031 filed on Mar. 21, 2018.

### BACKGROUND OF THE INVENTION

### A. Field of the Invention

This invention is related to a set of doors on a trailer that are capable of opening on more than one axis. The doors may alternatively be provided on a utility vehicle as well.

### B. Prior Art

Traditionally, trailer doors provided on trailers swing open either on a vertical axis or on a horizontal axis. In other words, the doors of the trailer would open either similar to barn doors or open downward onto the ground to then be used as a ramp. However, the two options are restrictive for users that require multiple uses of a trailer. For example, while doors that fold down to be used as a ramp is useful with driving a lawnmower on and off of the trailer or offloading items by hand, the ramp must be removed when using a forklift to offload pallets of items such as sod. Consequently, if an individual requires the use of a forklift, then the trailer must provide barn doors for forklift accessibility or provide a ramp that is removeable from the trailer. The removeable ramp can be helpful, but is cumbersome and awkward for one person to install or remove from the trailer. Furthermore, due to a ramp being removeable, it can be unintentionally left or forgotten.

Additionally, traditional trailer doors often restrict the length of an object that can be carried on the trailer. The device described in the present application, allows for each door to work in unison or work independently of one another. For example, one of the trailer doors could be folded down, while the other is completely closed. Alternatively, a door could be closed in an upright position, while the other door is completely open or entirely removed.

### BRIEF SUMMARY OF THE INVENTION

The device described herein door system that can be installed on a trailer. Although this invention is described as being installed on a trailer, it is anticipated that the door system may also be installed on a utility vehicle. This door system provides a first door and a second door. The first and second doors are attached to the trailer and can operate independently of one another by utilizing a plurality of hinges with quick-release pins. Each hinge assists with attaching a door to either the trailer or to the other door, thereby allowing the first and second doors of the door system to operate independently of one another or in unison with one another.

It is important that the hinges provide removeable quick-release pins that lock within the hinge to prevent the hinge from separating, but also enable the user to quickly and easily remove the hinge pins to open one of doors. It is anticipated that the trailer or utility vehicle can provide an area for holding one or more hinge pins when they are not in use.

Accordingly, a user may open the trailer doors as if they are barn doors or as a ramp. A user may connect the trailer doors together to then open or lower the two doors as one large door. The removeable hinges also enable a user to choose which direction to open the doors as one large door, which can be helpful in restrictive areas.

Moreover, this invention allows for placing a variety of different doors on the back of a trailer. For example, an individual may install one door that is a bi-fold door while the other door is designed to allow for securing tools, lengthy poles, or other equipment.

### BRIEF DESCRIPTION OF THE DRAWINGS

FIG. 1 is a front view of the first embodiment of the trailer door system showing a pair of doors in an upright closed position.

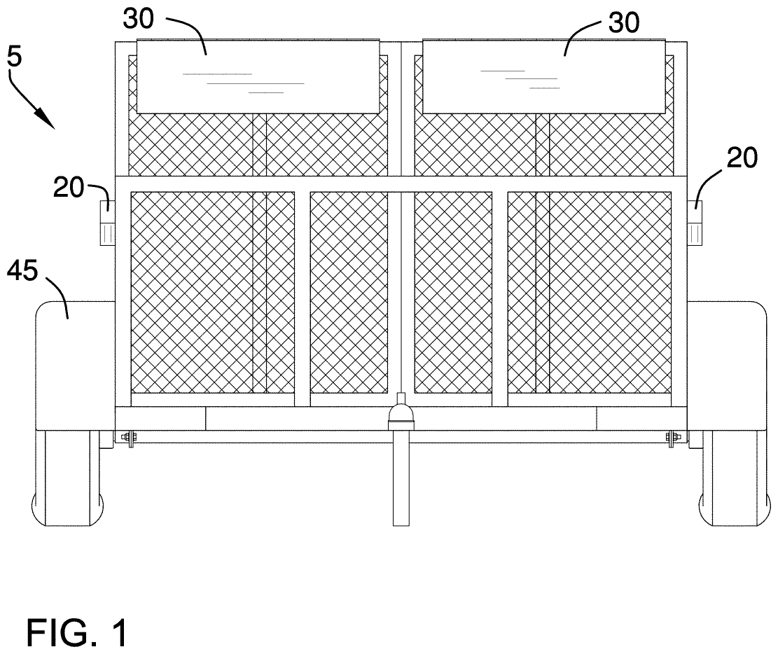

FIG. 2 is a rear view of the first embodiment of the trailer door system showing the pair of doors in an upright closed position.

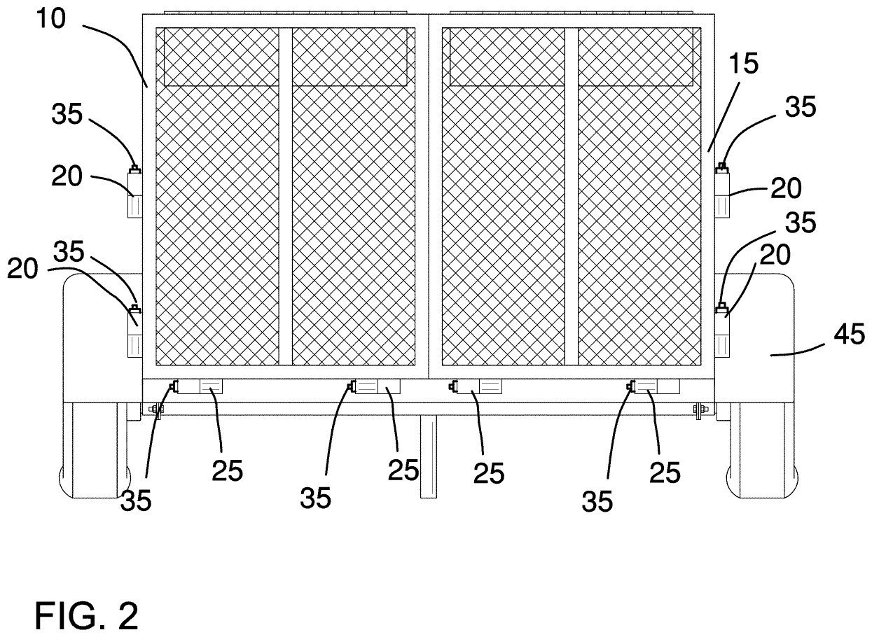

FIG. 3 is a side view of the first embodiment of the trailer door system showing the pair of doors in an upright closed position.

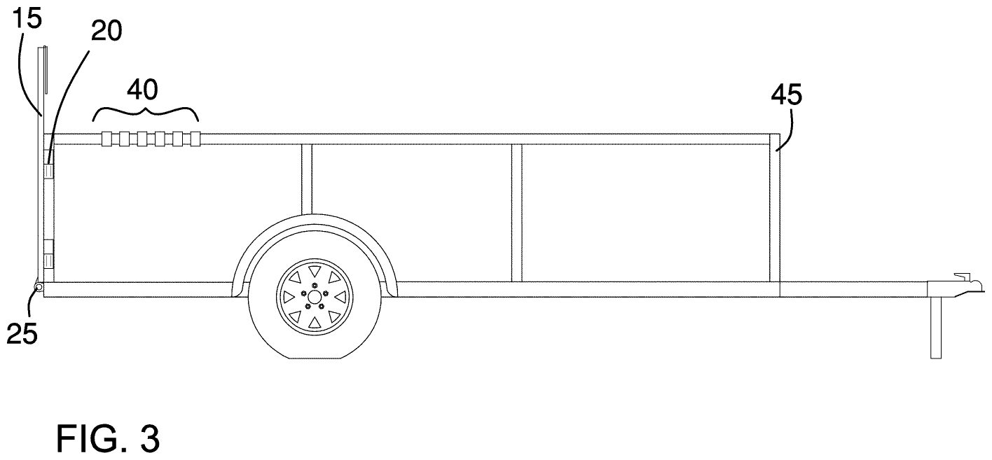

FIG. 4 is a side view of the first embodiment of the trailer door system showing the pair of doors lowered into a ramp position.

FIG. 5 is a top view of the first embodiment of the trailer door system showing the pair of doors with the first door in a lowered ramp position and the second door in an open barn door position.

FIG. 6 is a back view of the first embodiment of the trailer door system showing the first door and second door in an open barn door position.

FIG. 7 is an isometric view of first embodiment of the trailer door system showing one of the plurality of hinges where the quick-release hinge pin is removed.

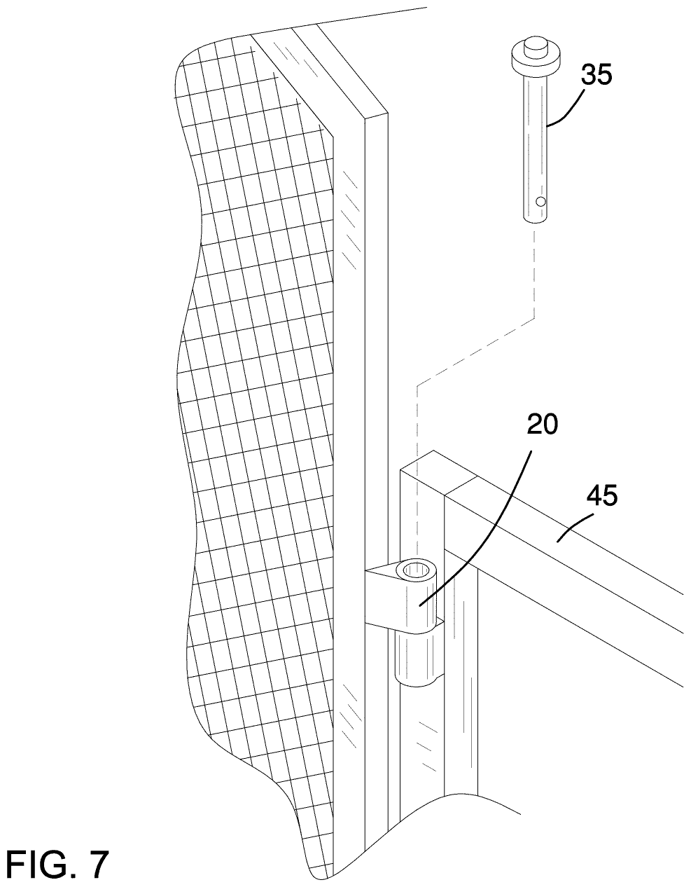

FIG. 8 is a rear view of the second embodiment of the trailer door system showing the first door and second door in an upright closed position while also attached together with a plurality of connectors.

### NUMBERING REFERENCE

5—Device
10—First door
15—Second door
20—Barn door hinge
25—Ramp door hinge
30—Ramp extension
35—Quick-release hinge pin
40—Hinge pin holder
45—Trailer
50—Door connector

### DETAILED DESCRIPTION OF THE EMBODIMENTS

This present device 5 is a trailer assembly that provides rear access door system, where each door is capable of opening independently and alternate between hingedly rotating on a horizontal axis or on a vertical axis. Although this device is described as being used on a trailer, it is anticipated that it may also be utilized on a van or other utility vehicle.

### First Embodiment

This first embodiment is comprised of a first door 10, a second door 15, a plurality of barn door hinges 20, a plurality of ramp door hinges 25, a plurality of ramp extensions 30, a plurality of quick-release hinge pins 35, and a plurality of hinge pin holders 40. The first door 10 provides a first side, a second side, a top side and a bottom side. The first side of the first door 10 is attached to the trailer with a plurality of barn-door hinges 20. The bottom side of the first door 10 is also attached to the trailer with a plurality of ramp-door hinges 25.

The second door 15 provides a first side, a second side, a top side, and a bottom side. The first side of the second door 15 is attached to the trailer with a plurality of barn-door hinges 20. The bottom side of the second door is attached to the trailer with a plurality of ramp-door hinges 25.

A removeable quick-release hinge pin 35 is provided for each barn-door hinge 20 and for each ramp-door hinge 25. Each removeable quick-release hinge pin 40 may be used in either the barn-door hinge 20 or the ramp-door hinge 25.

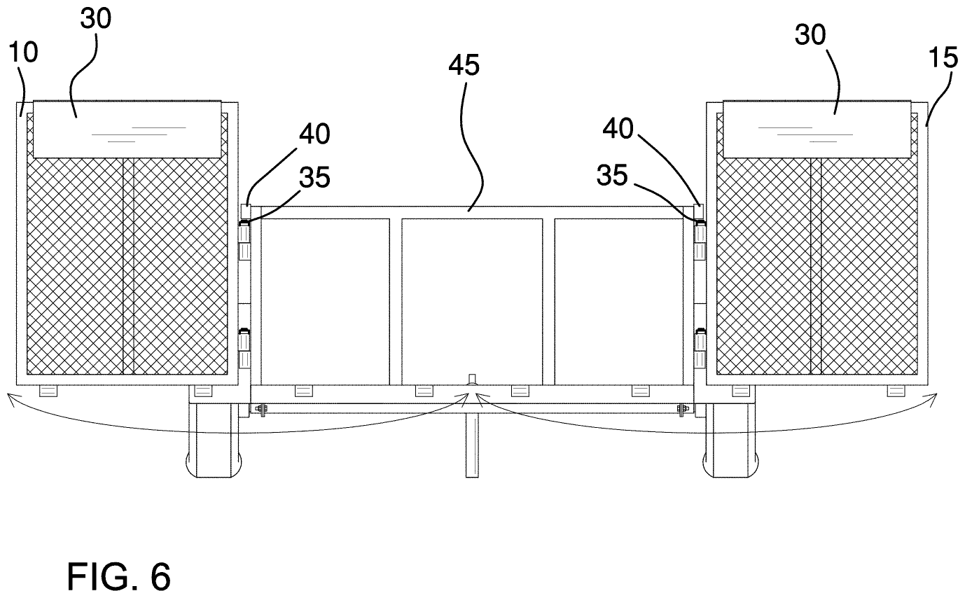

Accordingly, when the quick-release hinge pins 35 are provided in every barn-door hinge 20 and in every ramp-door hinge 25, the first door 10 and second door 15 are in a locked position. To open the first door 10 and second door 15 in a barn-door configuration, as shown in FIG. 6, the quick-release hinge pins 35 must be removed from the plurality of ramp-door hinges 25. When a hinge pin 35 is removed, it can be placed within a hinge pin holder 40 provided on the trailer 45.

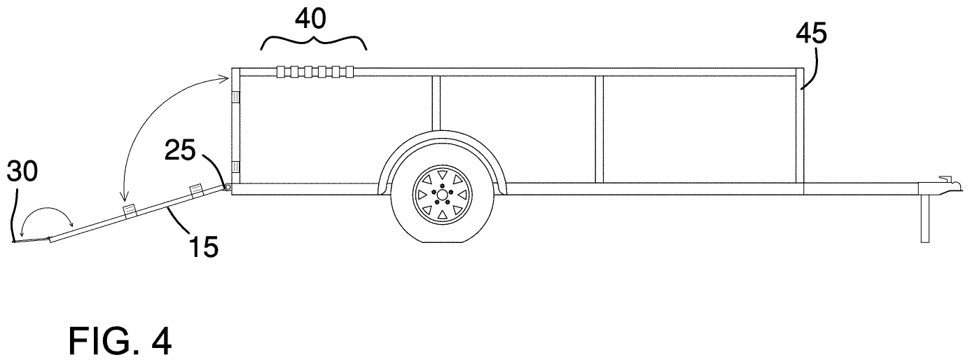

To open the first door 10 and second door 15 such that they each can be utilized as a ramp, all quick-release hinge pins 35 should be removed from the plurality of barn-door hinges 20. This allows the first door 10 and second door 15 to rotate along the ramp-door hinges 25, which is shown in FIG. 4.

This door system additionally provides a ramp extension 30, which allows for a relatively smooth transition between the ground and the doors when they are in a ramp configuration. Once the door or doors are lowered to operate as a ramp the ramp extension 30 may be rotated as shown in FIG. 4.

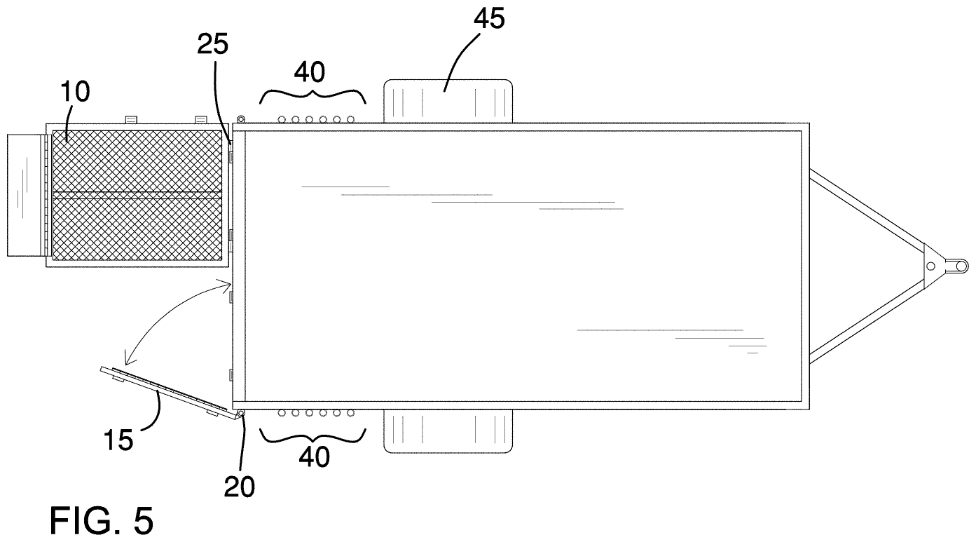

While this door system provides a user with the choice of utilizing a trailer with a barn-door configuration or a ramp configuration, it additionally allows an individual to use the trailer 45 by only opening one of the doors as a barn-door and lowering only one of the doors to be used as a ramp. For example, as shown in FIG. 5, this door systems allows a user to lower the first door 10 to be used as a ramp and then open the second door 15 as a barn-door.

### Second Embodiment

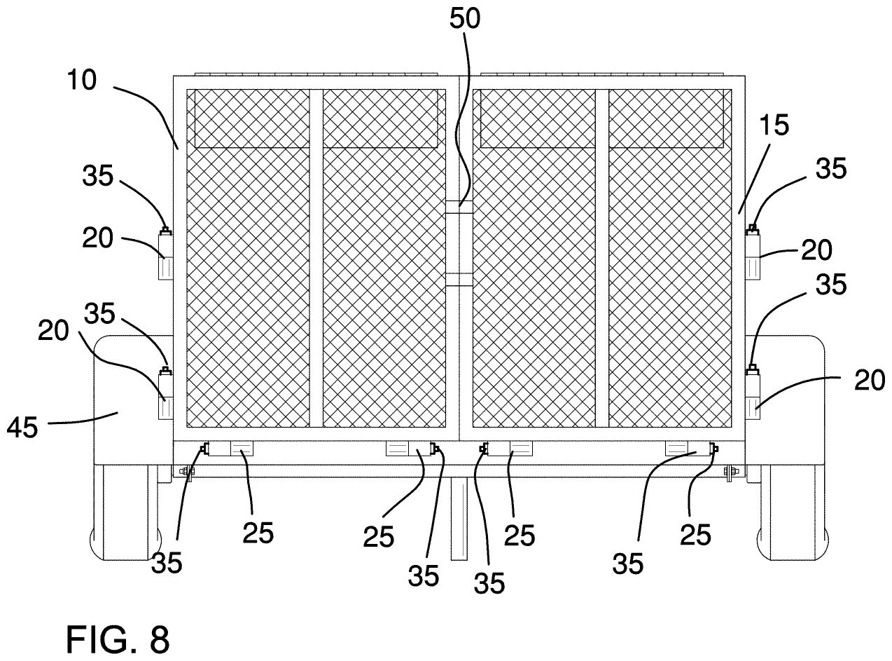

This second embodiment is comprised of the first embodiment with the addition of a plurality of door connectors 50. This door system may additionally allow for connecting the second side of the first door 10 to the second side of the second door 15. Consequently, the two doors can then operate as a single door if desired. Therefore, a user will have more options to access the rear of a trailer with the present door system. This can be accomplished with the use of a connection device 50 which provides to two cylindrical parts. A first cylindrical part that is affixed to the second side of the first door 10 and a second cylindrical part that is affixed to the second side of the second door 15. A quick-release hinge pin 35 is then inserted through the first and second cylindrical parts to then connect the second side of the first door 10 to the second side of the second door 15. Although FIG. 8 shows two connectors 50 being used to attach the first door 10 to the second door 15, it is anticipated that more connectors 50 may be added.

While the embodiments of the invention have been disclosed, certain modifications may be made by those skilled in the art to modify the invention without departing from the spirit of the invention.

The inventors claim:

1. A trailer door system, which is comprised of:
a. a trailer;
wherein the trailer provides a rear end;
wherein the rear end of the trailer provides a frame;
b. a first door;
wherein the first door provides a first side, a second side, a top side, and a bottom side;
wherein a plurality of barn-door hinges attaches the first side of the first door to the frame of the trailer;
wherein a plurality of ramp-door hinges attaches the bottom side of the first door to the frame of the trailer;
c. a second door;
wherein the second door provides a first side, a second side, a top side, and a bottom side;
wherein a plurality of barn-door hinges attaches the first side of the second door to the frame of the trailer;
wherein a plurality of ramp-door hinges attaches the bottom side of the second door to the frame of the trailer;
d. a plurality of quick-release hinge pins;
wherein each of the plurality quick-release hinge pins are provided within each of the plurality of barn-door hinges;
wherein each of the plurality quick-release hinge pins are provided within each of the plurality of ramp-door hinges;

2. The trailer door system described in claim 1, wherein the trailer provides a plurality of quick-release hinge pin holders.

3. The trailer door system described in claim 1, wherein a first ramp extension is attached to the first door and a second ramp extension is attached to the second door.

4. The trailer door system described in claim 5, wherein the second side of the first door and second side of the second door are attached together with at least one connector that locks when one of the quick-release hinge pins is inserted into the connector.

5. A vehicle door system, which is comprised of:
a. a vehicle;
wherein the trailer provides a rear end;
wherein the rear end of the vehicle provides a frame;
b. a first door;
wherein the first door provides a first side, a second side, a top side, and a bottom side;
wherein a plurality of barn-door hinges attaches the first side of the first door to the frame of the vehicle;
wherein a plurality of ramp-door hinges attaches the bottom side of the first door to the frame of the vehicle;
c. a second door;
wherein the second door provides a first side, a second side, a top side, and a bottom side;
wherein a plurality of barn-door hinges attaches the second door to the frame of the trailer;
wherein a plurality of ramp-door hinges attaches the second door to the frame of the vehicle;
d. a plurality of quick-release hinge pins;
wherein each of the plurality quick-release hinge pins are provided within each of the plurality of barn-door hinges;
wherein each of the plurality quick-release hinge pins are provided within each of the plurality of ramp-door hinges;

6. The vehicle door system described in claim 5, wherein the trailer provides a plurality of quick-release hinge pin holders.

7. The vehicle door system described in claim 5, wherein a first ramp extension is attached to the first door and a second ramp extension is attached to the second door.

8. The vehicle door system described in claim 5, wherein the second side of the first door and second side of the second door are attached together with at least one connector that locks when one of the quick-release hinge pins is inserted into the connector.
